(19) United States
(12) Patent Application Publication
(10) Pub. No.: US 2026/0304089 A1
(43) Pub. Date: Oct. 1, 2026

(54) SYSTEMS AND METHODS FOR ENABLING TEMPORARY SATELLITE SUBSCRIPTION

(71) Applicant: T-Mobile Innovations LLC, Overland Park, KS (US)

(72) Inventors: Zaheer Mohammed SIDDIQUE, Overland Park, KS (US); Ryan Patrick DREILING, Shawnee, KS (US)

(21) Appl. No.: 19/090,623

(22) Filed: Mar. 26, 2025

(51) Int. Cl. H04W 4/90; H04W 48/02; H04W 84/06

(52) U.S. Cl. CPC H04W 4/90; H04W 48/02; H04W 84/06

(57) ABSTRACT

Systems, methods and devices are provided for enabling temporary satellite service subscription. The method includes generating, by a wireless device, a message service request comprising a destination address of a public safety answering point (PSAP), in response to receiving a network identifier of a satellite network that is contacted by the wireless device for servicing the message service request comprising the destination address, modifying, by the wireless device a forbidden public land mobile network (FPLMN) list to remove the network identifier of the satellite network and transmitting the message service request to the PSAP using the satellite network.

### TECHNICAL BACKGROUND

Satellite networks often require a subscription for connection. User devices that are not subscribed to the satellite network services, in many situations, will include an identifier associated with that satellite network as part of a forbidden public land mobile network (FPLMN), which is usually stored in a subscriber identity module (SIM) of that user device. This FPLMN list may be pre-populated when the user device is configured for use or populated based on a denial of attachment by that satellite network.

### OVERVIEW

Exemplary embodiments described herein include systems, methods, and processing nodes for enabling temporary satellite service subscription. An exemplary method includes generating, by a wireless device, a message service request comprising a destination address of a public safety answering point (PSAP), in response to generating the message service request comprising the destination address, modifying, by the wireless device, a FPLMN list and transmitting the message service request to the PSAP using a satellite network.

Further exemplary embodiments include a system for enabling temporary satellite service subscription. The system includes a satellite network and a computing device communicatively connected to the satellite network, wherein the computing device comprises at least one processor configured to generate a message service request comprising a destination address of a public safety answering point (PSAP), in response to generating the message service request comprising the destination address, modify a FPLMN list and transmit the message service request to the PSAP using the satellite network.

In yet a further exemplary embodiment, a non-transitory computer readable medium is provided. The non-transitory computer-readable medium stores instructions, when executed by a processor, configuring the processor to generate a message service request comprising a destination address of a public safety answering point (PSAP), in response to generating the message service request comprising the destination address, modify a FPLMN list and transmit the message service request to the PSAP using a satellite network.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates a decision flow diagram for enabling temporary satellite service subscription in accordance with disclosed embodiments;

FIG. 3 illustrates an exemplary process flow for enabling temporary satellite service subscription in accordance with aspects of this disclosure;

FIG. 4 illustrates an example of a computing device in accordance with aspects of this disclosure; and

FIG. 5 illustrates an exemplary processing node in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a wireless device, such as a smartphone with satellite connection capability, is configured to enable temporary access to a satellite network through modification of a FPLMN list.

Wireless devices may be programmed to access a FPLMN list within a SIM of the device. In certain conditions, this FPLMN list may be modified so the wireless device can gain access to a network that was otherwise forbidden from being accessed. For example, a user may be stranded in a remote location, such as a person that gets lost hiking in a forest isolated from populated areas.

The wireless device may be in a location without any terrestrial network coverage but may still be able to access a satellite network. For example, many modern smartphones include antennas capable of connecting to low earth orbit satellites.

Because satellite networks often require a subscription to those services, a wireless device trying to connect may be forbidden from doing so without subscribing to the service. In many cases, the SIM of the wireless device may be preprogrammed to not allow connection to the satellite network, or in other cases the FPLMN list is populated once the attachment to the satellite network is rejected.

A wireless device may also include configurations that enables the FPLMN list to be modified so a user can access a satellite network in case of an emergency. For example, the wireless device may be configured to remove the satellite network from the FPLMN upon detecting that the destination of the connection is the satellite network. Since a textual message, such as SMS, requires very low bandwidth to send the emergency message, it may be desirable to initiate contact with emergency services through this medium when relying on a satellite connection. Once gaining access to the satellite network, emergency services, such as PSAP, may utilize other mediums to further contact the user of the wireless device. For example, a person may send a SMS containing coordinates of the wireless device to emergency services, such as by sends an SMS to “911.” Once the user no longer requires the emergency connection, the satellite network may transmit an over-the-air (OTA) transmission configuring the wireless device to add the satellite network back to the FPLMN list.

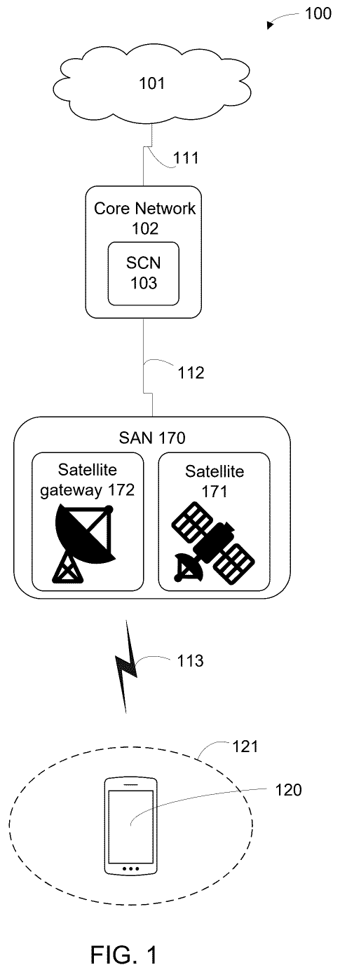

These and other examples will be described in greater detail below in relation to FIGS. 1-5.

FIG. 1 depicts an exemplary system 100 for enabling a temporary satellite service subscription. System 100 includes a communication network 101, a core network 102, a satellite access network (SAN) 170 and wireless devices 120.

Core network 102 is connected to communication network 101 over communication link 111. Core network 102 includes a satellite core network (SCN) 103. SCN 103 as used herein are core network components used for managing data for satellite-based connections, and/or other networks. In embodiments, SCN 103 may include a satellite network short message service center (SMSC). The satellite SMSC is responsible for storing processing and forwarding SMS messages to a terrestrial network. Non-terrestrial and terrestrial networks may include 4G/LTE, new radio 5G, 6G, and the like. SCN 103 may also include a satellite core gateway (SCG). The SCG is responsible for converting satellite signaling into terrestrial signaling. For example, SCG may be used by satellite SMSC to forward a SMS message to a PSAP connected to a ground network. The PSAP receiving the SMS message may include SMS-enabled devices, next generation 911 (NG911) systems, and the like. It should be noted that SCG may serve as an interface between SAN 170 and SCN 103, and also as a routing component.

In instances, SCN 103 may include a satellite mobility management function (SMMF). The SMMF is responsible for authenticating a connecting wireless device, such wireless device 120 to the SAN 170, and for session management, such as establishing, modifying or terminating a satellite session. For example, SMMF may be used for authenticating a connecting wireless device to the SAN 170, and for detaching the wireless device from the SAN 170 based on a changing condition, such as a modification of a FPLMN.

It should be noted that core network 102 may include other components used for managing data for networks not described herein, such as a non-terrestrial 6G core network. Furthermore, it should also be noted that in embodiments, the core network 102 may have other types of core architecture that at least perform some similar functions as and/or share at least some components with SCN 103. For example, embodiments described herein may utilize an artificial intelligence (AI)-enhanced satellite access and mobility management function (S-AMF) of a 6G non-terrestrial network to manage the SAN 170.

The SAN 170 includes satellites, such as satellite 171, and satellite gateway 172. In embodiments, the satellites may be referred to as satellite base stations (SBASs). As used herein, an SBAS is a base station in a satellite network used for connecting a user device, such as wireless device 120, to core network 102. Satellite 171 may include a low-earth orbit (LEO) satellite, a medium-earth orbit (MEO) satellite or a geostationary earth orbit (GEO) satellite. In embodiments, such as for a 6G non-terrestrial network, satellite 171 may include a deep space satellite. In embodiments, SAN 170 may include inter-satellite links (ISLs) used for connection between two or more satellites 171.

Satellite gateway 172 is used for forwarding the connection for a wireless device, such as wireless device 120, from satellite 171 to core network 102. For example, a wireless device 120 may transmit a message request, such as an SMS, to a PSAP by transmitting the request to a satellite 171, which then forwards the request to the satellite gateway 172. The satellite gateway 172 is then responsible for forwarding the request to SCN 103 to be handled. In instances, satellite gateway 172 may receive transmissions from SCN 103 to be forwarded to a wireless device 120 through satellite 171.

SAN 170 is connected to core network 102 over communication link 112. SAN 170 may include other devices and additional nodes not described herein. For example, the SBAS may include satellite payload transponders and processors.

In embodiments, system 100 may include multiple wireless devices 120. These wireless devices are configured to operate in one or more coverage areas 121. Wireless devices 120 may include an end-user wireless device and/or any device configured for satellite connection. In instances, wireless devices 120 may include a wireless device that is equipped with an integrated SIM (eSIM) or a wireless device that includes a removable SIM card. In embodiments, a wireless device 120 communicates with SAN 170 over communication link 113. Examples of communication link 113 may include a 5G satellite network (NTN), a 6G satellite network, and the like.

Communication network 101 may be a wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless devices 120. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), 6G and/or non-terrestrial networks, such as GEO satcom, MEO satcom, LEO satcom, and the like. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or so forth. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The satellite user data function (SUDF) accesses a data network, such as network 101, and performs operations such as packet routing and forwarding, packet inspection, policy enforcement for the user plane, quality of service (QoS) handling, etc. The control plane functions may include, for example, a satellite slice selection function (SSSF), a satellite network repository function (NRF), a SMMF, a satellite policy control function (SPCF). Additional or fewer control plane functions may also be included. The SMMF receives connection and session related information from the wireless devices 120 and is responsible for handling connection and mobility management tasks. The SMMF is also responsible for creating, updating, and removing sessions and managing session context. The SMMF stores and manages satellite authentication for wireless device 120, access control and subscriber data.

Although one core network 102 is shown, multiple core networks 102 may be utilized. Alternatively, the single core network 102 may include a distributed, cloud-native, converged core gateway. Thus, the converged core gateway could connect an SCN 103 to terrestrial networks such as 5GC or LTE networks.

Communication links 111 and 112 can use various communication media, such as air, space, metal conductors, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, SAN 170 may include various access network systems and devices such as a SBAS in the form of satellite 171. The SAN 170 is disposed between the core network 102 and the end-user wireless device 120. Components of the SAN 170 may communicate directly with the core network 102 and others may communicate directly with the end user wireless device 120. The SAN 170 may provide services from the core network 102 to the end-user wireless device 120. It is understood that the disclosed technology may also be applied to communication between an end-user wireless device and other network resources, such as relay nodes, controller nodes, antennas, etc. Further, multiple access nodes may be utilized. For example, some wireless devices may communicate with a SBAS located in a LEO satellite 171 and others may communicate with a SBAS located in a MEO satellite 171.

In additional embodiments, the SBASs may comprise two types of SBASs, such as a LEO SBAS and a GEO SBAS. As will be further described below, functionality for network node switching may be included within the SBAS. For example, a SBAS may include a master control station (MCS), which is responsible for switching connection to another satellite 171 or a ground station. It would be evident to one of ordinary skill in the art, in light of this disclosure, the many other combinations of SBASs that can be utilized.

The SBAS may include a processor and associated circuitry to execute or direct the execution of computer-readable instructions to perform operations such as those further described herein. SBAS can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 120 may include any wireless device included in a wireless network. For example, the term “wireless device” may include a relay node, which may communicate with an access node. The term “wireless device” may also include an end-user wireless device, which may communicate with SBAS of satellite 171 through a relay node. The term “wireless device” may further include an end-user wireless device that communicates with satellite 171 directly, without the need of a relay node. In instances, some categories of satellite 171 may require the use of a relay, such as MEO satellites, even if the wireless device has the capability of communicating with a satellite 171 without the use of a relay.

Wireless devices 120 may be any device, system, combination of devices, or other such communication platform capable of communicating with satellite 171 using one or more frequency bands and wireless carriers deployed therefrom. Each of wireless devices 120, may be, for example, a mobile phone with direct-to-satellite connectivity, a wireless phone, a satellite phone, a satellite internet device, a satellite-enabled mobile router, a satellite ground station, or a unnamed aerial vehicle (UAV), a personal locator beacon (PLB), an internet of things (IoT) device, as well as other types of devices or systems that can send and receive data. The wireless device 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the SAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for network node switching may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

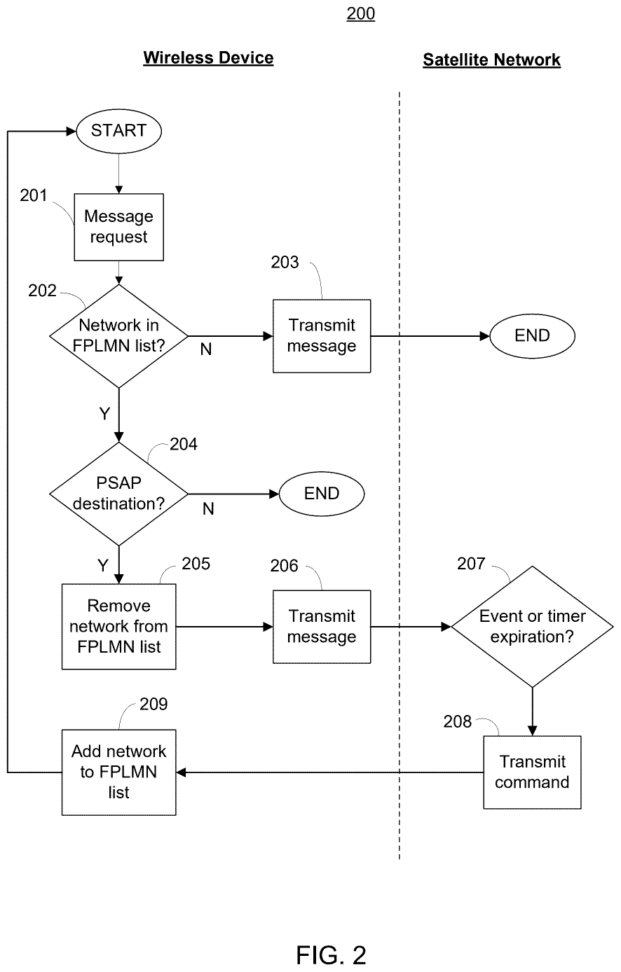

Now referring to FIG. 2, an example decision flow 200 is presented. In this example, the flow begins, at step 201, by a wireless device generating a message request. In this example, the message request is a short message service (SMS) message. The SMS message includes a heading with the destination address, such as a phone number. Once the message request is generated, the wireless device attempts to connect to a wireless network for servicing the request. In this example, the wireless device is not connected to a network at the time the message service request is generated. If no terrestrial wireless networks are available, such as 5G or LTE, the wireless device attempts to contact a satellite network for servicing the SMS message request. For example, the wireless device may send a connection request to a SBAS of the satellite network.

Upon attempting to contact the satellite network, at step 202, the wireless device queries a FPLMN for a PLMN identifier (ID) associated with the satellite network. For example, in response to the attempt to connect from the wireless device, the satellite network may transmit a response to the wireless device that includes the PLMN ID associated with the satellite network via the SBAS of the satellite network. Subsequently, the wireless device queries the FPLMN list for the PLMN ID, which includes a mobile country code (MCC) and a mobile network code (MNC), associated with the satellite network. The FPLMN list may be stored in a SIM of the wireless device. In instances, the SIM may be a removable SIM or an embedded SIM (eSIM). If the PLMN ID associated with the satellite network is not present in the FPLMN list, at step 203, the wireless device successfully transmits the SMS message and the flow ends.

If the PLMN ID queried is associated with the satellite network, which the wireless device is attempting to connect, the wireless device checks the destination address (i.e., destination phone number) for the SMS message request. At step 204, the wireless device verifies that the destination address is associated with an emergency service, such as a PSAP in this example. The PSAP destination address may include short codes such as 911, 112, 999, and the like.

In other examples, the wireless device may also be programmed to check for unrestricted numbers. For example, an unrestricted number may be a number enabling the user to sign up for the satellite network service which the wireless device is attempting to connect to. In such an example, sending an SMS message to the unrestricted number may cause an application of the satellite network to provide the wireless device with access to a service portal (e.g., a subscription portal) that enables the user to subscriber to one or more telecommunication services provided by the satellite network. If the destination address is not associated with an emergency service operator or an unrestricted number, the wireless device does not attempt to attach to the satellite network.

If the destination address is an emergency service, or unrestricted number, the wireless device, at step 205, removes the PLMN ID associated with the satellite network from the FPLMN list. In instances, removing the PLMN ID may include a command by wireless device sent to the SIM, such as an attention (AT) command. Once the PLMN ID associated with the satellite network is removed from the FPLMN list, the wireless device attaches to the satellite network and, at step 206, transmits the message to the destination address.

As noted in this disclosure, the access to the satellite network is temporary in order to allow a user to contact emergency services when terrestrial wireless networks are unavailable. As such, the satellite network verifies whether a condition for ending the access has been met. In this example, the satellite network, at step 207, checks for the event expiration and/or a timer expiration. For example, the satellite network awaits a signal from the PSAP that the emergency event has been concluded, or at least that the satellite network connection is no longer needed. The satellite network may also set a timer for the expiration of the connection once the message is forwarded to PSAP. If either of those conditions are met, at step 208, the satellite network transmits an over-the-air (OTA) command configuring the wireless device to add the PLMN ID associated with the satellite network back to the FPLMN list. Any subsequent message service requests would follow the same flow described.

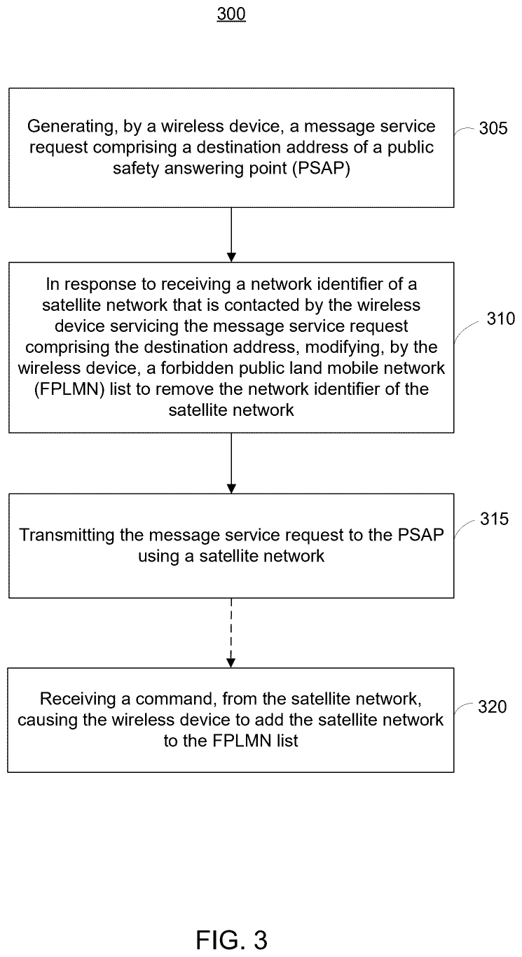

With reference to FIG. 3, a flow diagram of method 300 for enabling temporary satellite service subscription is presented. Method 300 includes, at step 305, generating, by a wireless device, a message service request comprising a destination address. In embodiments, the destination address is the phone number associated with a PSAP. For example, the message service request may be SMS that includes a short code, such as “911”, for a PSAP. In instances, the wireless device may be the same as wireless device 120 described in reference to FIG. 1.

In embodiments, the destination address may be an unrestricted number. For example, the unrestricted number may be a mobile station international subscriber directory number (MSISDN) associated with an operator number of the satellite network that enables a user to sign up for a satellite service subscription.

At step 310, method 300 includes in response to receiving a network identifier of a satellite network that is contacted by the wireless device for servicing the message service request comprising the destination address, modifying by the wireless device a FPLMN list. In embodiments, modifying the FPLMN list comprises removing a network identifier associated with the satellite network from the FPLMN list. For example, the wireless device may remove a PLMN ID associated with satellite network from the FPLMN list. In embodiments, the FPLMN list is stored in a secure storage module. In embodiments, the secure storage module may include a SIM. The SIM may be a SIM chip or an eSIM. In embodiments, modifying the FPLMN list may include updating an elementary file for FPLMNs (EF_FPLMN). IN instances, modifying the FPLMN list may include sending an AT command to the SIM.

The method 300 includes, at step 315, transmitting the message service request to the PSAP using a satellite network following the modification of the FPLMN list. For example, the removal of the network identifier of the satellite network from the FPLMN list permits the wireless device to attach to the satellite network. Following attachment of the wireless device to the satellite network, the message service request may be transmitted by the satellite network to the PSAP associated with the destination address

At step 320, method 300 may include receiving a command, from the satellite network, causing the wireless device to add the satellite network to the FPLMN list. In embodiments, the command is received based on the expiration of an event associated with the message service request. For example, the command may be received based on the satellite network no longer being needed for an emergency associated with the message service request. In instances, the command is received based on a timer set in response to transmitting the message service request to the PSAP. For example, the timer may be set for a period that allows for an interaction with the PSAP to be resolved, such as setting a timer for over an hour, which would be far above average call durations to PSAP. A user would be capable of contacting, or be contacted by, an operator of the satellite network to sign up for a subscription plan during this period, thus ensuring continued connection if the emergency requires longer connection to the satellite network than the set timer. Further, receiving the command may be based on meeting any of the conditions described above. For example, the command may be received based on the emergency being resolved, such as by receiving a signal from the PSAP, even if the timer has not expired. It should be noted that, in embodiments, even if the network identifier of the satellite network is added back to the FPLMN list, a subsequent message service request transmitted to the PSAP would retrigger the steps described above.

In some embodiments, methods 300 may include additional steps or operations. Furthermore, the methods may include steps shown in each of the other methods. As one of ordinary skill in the art would understand, method 300 may be integrated in any useful manner and the steps may be performed in any useful sequence.

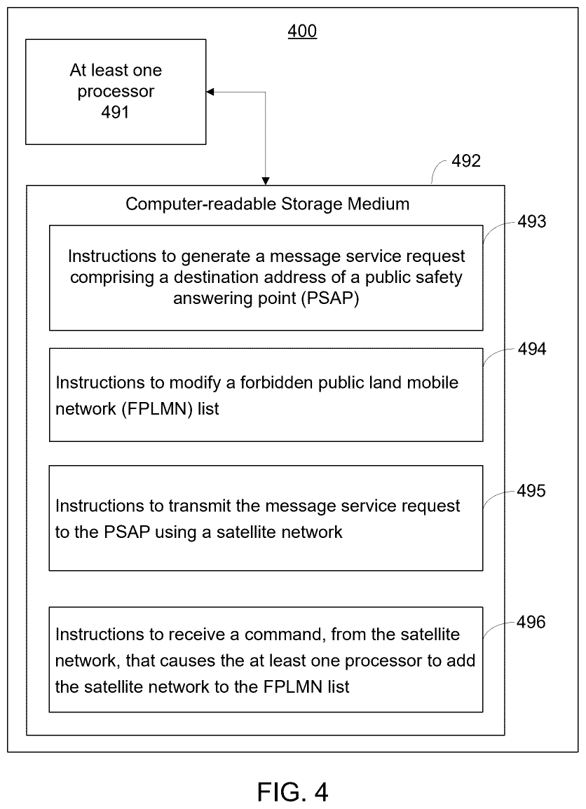

Now referring to FIG. 4, an example computing device 400 is presented. In embodiments, computing device 400 may include a node device, such as devices operating within communication network described in reference to FIG. 1. In this example, computing device 400 includes at least one processor 491 communicably coupled to a computer-readable storage medium 492. The at least one processor 491 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 492. In instances, at least one processor 491 may include electronic circuitry for performing instructions described in this disclosure.

In instances, computer-readable storage medium 492 may be any medium suitable for storing executable instructions. In examples, without limitation, computer-readable storage medium 492 may include read-only memory (ROM), random-access memory (RAM), erasable electrically programmable ROM (EEPROM), Solid State Drive (SSD), optical disc, and the like. Computer-readable medium storage 492 may be disposed within computing device 400. In embodiments, computer-readable storage medium 492 may be external, and communicably connected, to computing device 400. The instruction stored on computer-readable storage medium may be used to implement method steps described in reference to FIG. 3.

In this example, computer-readable storage medium 492 is encoded with a set of instructions 493, 494 and 495. In instances, computer-readable storage medium 492 may be further encoded with instruction 496. In embodiments, executable instructions included in each block may be included in different blocks shown and blocks not shown.

Instruction 493, when executed by at least one processor 491, configures the at least one processor 491 to generate a message service request comprising a destination address of a PSAP. For example, the destination address may be a short number. In embodiments, the destination address may be an unrestricted number, such as an MSISDN associated with an operator of the satellite network that enables a user to sign up for satellite connection services.

Instruction 494, when executed by at least one processor 491, configures the at least one processor 491 to modify a FPLMN list to remove a network identifier of a satellite network in response to receiving the network identifier of the satellite network that is contacted by the at least one processor 491 for servicing the message service request comprising the destination address.

Instruction 495, when executed by at least one processor 491, configures the at least one processor 491 to transmit the message service request to the PSAP using a satellite network following modification of the FPLMN list.

Instruction 496, when executed by at least one processor 491, configures the at least one processor 491 to receive a command, from the satellite network, that causes the at least one processor to add the network identifier of the satellite network to the FPLMN list.

In embodiments, computer-readable storage medium 492 may include instructions configuring the at least one processor 491 to assign a temporary subscriber directory number to the wireless device and initiate an authentication session for the authentication request based on the subscriber identifier and the temporary subscriber directory number.

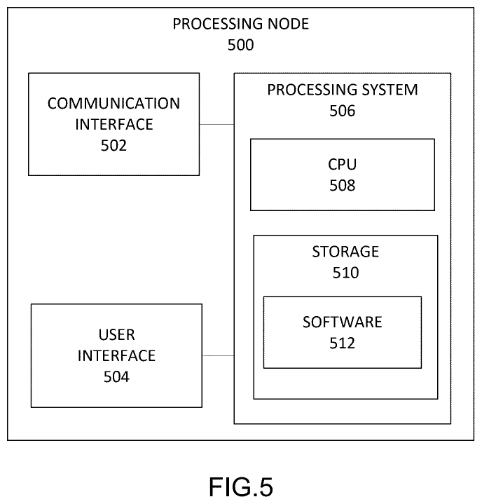

Now referring to FIG. 5, an example processing node 500, which may be configured to perform the methods and operations disclosed herein for network energy reduction. The processing node 500 includes a communication interface 502, user interface 504, and processing system 506 in communication with communication interface 502 and user interface 504. Communication interface 502 may include hardware components, such as network communication ports, devices, routers, wires, antenna, electronically steerable antennas (ESA), transceivers supporting satellite bands, etc. User interface 504 may include hardware components, such as touch screens, buttons, displays, speakers, etc.

Processing system 506 includes a central processing unit (CPU) or processor 508 and storage 510. Storage 510 may include a disk drive, flash drive, memory circuitry, or other memory device including, for example, a buffer. Storage 510 can store software 512 which is used in the operation of the processing node 500. Software 512 may include computer programs, firmware, or some other form of machine-readable instructions, including an operating system, utilities, drivers, network interfaces, signal processing algorithms, applications, or some other type of software. Processing system 506 may include a processor 508 and other circuitry to retrieve and execute software 512 from storage 510, which may be internal or external to the processing system 506. Processing node 500 may further include other components such as a power management unit, a control interface unit, etc., which are omitted for clarity. Communication interface 502 permits processing node 500 to communicate with other network elements. User interface 504 permits the configuration and control of the operation of processing node 500. Processing node 500 may be included in various elements of the satellite network including an access node, satellite policy control function (S-PCF), satellite network selection and orchestration (S-NSO), satellite roaming gateway (S-RG), satellite network repository function (S-NRF), and the like. In this example, software 512 may include the instructions described in reference to FIG. 4.

Although the descriptions provided herein may be in the context of certain radio access technologies, networks, and network topologies, such as 3GPP 4G/5G non-terrestrial networks (NTN) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
generating, by a wireless device, a message service request comprising a destination address of a public safety answering point (PSAP);
in response to receiving a network identifier of a satellite network that is contacted by the wireless device for servicing the message service request comprising the destination address, modifying, by the wireless device, a forbidden public land mobile network (FPLMN) list to remove the network identifier of the satellite network; and
transmitting the message service request to the PSAP using the satellite network following modification of the FPLMN list.

2. The method of claim 1, wherein modifying the FPLMN list comprises removing a PLMN identifier (ID) associated with the satellite network.

3. The method of claim 1, further comprising receiving a command, from the satellite network, that causes the wireless device to add the network identifier of the satellite network to the FPLMN list.

4. The method of claim 3, wherein the command is received based on an expiration of an event associated with the message service request.

5. The method of claim 3, wherein the command is received based on an expiration of a timer, wherein the timer is set in response to transmitting the message service request to the PSAP.

6. The method of claim 1, wherein the destination address comprises an unrestricted number.

7. The method of claim 1, wherein the FPLMN list is stored in a subscriber identity module (SIM) of the wireless device.

8. The method of claim 7, wherein modifying the FPLMN list comprises updating an elementary file for FPLMNs (EF_FPLMN).

9. The method of claim 7, wherein modifying the FPLMN list comprises sending an Attention (AT) command to the SIM.

10. The method of claim 1, wherein the message service request is a short message service (SMS) message request.

11. A system, the system comprising:
a satellite network;
a computing device communicatively connected to the satellite network, wherein the computing device comprises at least one processor configured to:
generate a message service request comprising a destination address of a public safety answering point (PSAP);
in response to receiving a network identifier of the satellite network that is contacted by the computing device for servicing the message service request comprising the destination address, modify a forbidden public land mobile network (FPLMN) list to remove the network identifier of the satellite network; and
transmit the message service request to the PSAP using the satellite network following modification of the FPLMN list.

12. The system of claim 11, wherein modifying the FPLMN list comprises removing a PLMN identifier (ID) associated with the satellite network.

13. The system of claim 12, wherein the computing device is further configured to receive a command, from the satellite network, that causes the computing device to add the network identifier of the satellite network to the FPLMN list.

14. The system of claim 13, wherein the command is received based on an expiration of an event associated with the message service request.

15. The system of claim 13, wherein the command is received based on an expiration of a timer, wherein the timer is set in response to transmitting the message service request to the PSAP.

16. The system of claim 11, wherein FPLMN is stored in a subscriber identity module (SIM) of the computing device.

17. A non-transitory computer-readable medium storing instructions, when executed by at least one processor, configuring the at least one processor to:
generate a message service request comprising a destination address of a public safety answering point (PSAP);
in response to receiving a network identifier of a satellite network that is contacted by the at least one processor for servicing the message service request comprising the destination address, modify a forbidden public land mobile network (FPLMN) list to remove the network identifier of the satellite network; and
transmit the message service request to the PSAP using the satellite network following modification of the FPLMN list.

18. The non-transitory computer-readable medium storing instructions of claim 17, wherein modifying the FPLMN list comprises removing a PLMN identifier (ID) associated with the satellite network.

19. The non-transitory computer-readable medium storing instructions of claim 17, wherein the at least one processor is further configured to receive a command, from the satellite network, that causes the at least one processor to add the network identifier of the satellite network to the FPLMN list.

20. The non-transitory computer-readable medium storing instructions of claim 19, wherein the command is received based on an expiration of:
an event associated with the message service request; or
a timer, wherein the timer is set in response to transmitting the message service request to the PSAP.
